(19) United States
(12) Patent Application Publication
(10) Pub. No.: US 2015/0107526 A1
(43) Pub. Date: Apr. 23, 2015

(54) COLLAPSIBLE PET CONTAINMENT APPARATUS WITH FOLDABLE SIDE WALLS

(71) Applicant: Charlotte Lemon, Mount Pleasant, SC (US)

(72) Inventor: Charlotte Lemon, Mount Pleasant, SC (US)

(21) Appl. No.: 14/057,953

(22) Filed: Oct. 18, 2013

(51) Int. Cl. A01K 1/03

(52) U.S. Cl. CPC A01K 1/03
USPC 119/499; 119/416; 119/514

(57) ABSTRACT

A collapsible pet containment apparatus with foldable side walls to enable selective containment of a pet. Embodiments of the present disclosure provide a pet containment apparatus that can be configured from an extended position to a folded position. The apparatus may have a fabric perimeter defining a bottom and side walls terminating around an upper frame perimeter. The upper frame perimeter may be selectively lowered to allow independent entrance and exit from an interior portion of the apparatus, defined by the fabric perimeter, by a pet such as a dog.

### FIELD

The present disclosure relates to the field of pet exercise and containment enclosures, in particular, a collapsible pet containment apparatus with foldable side walls to enable selective containment of a pet.

### BACKGROUND

Pet owners want to make their pets or animal companions as comfortable as reasonably possible, both physically and emotionally. In this regard, pet owners often provide “safe places,” i.e. familiar, comfortable places for their pets to retire; or, a confinement enclosure or device to restrict the pet's independence when unattended. Crates, playpen, walled enclosures, and the like are popular among pet owners and are well known in the art.

Pet owners often travel with their pets. The ability to easily travel with a pet confinement enclosure is highly desirable in order to provide the pet with the same “safe place” as home, or to restrict the pet's independence in an area such as a hotel room. Numerous examples exist in the art of foldable or transportable crates or enclosures. U.S. Pat. No. 7,712,437 discloses a mobile pet bed wherein the top and bottom units of the mobile pet bed are reversibly attached to each other. When the top unit is removed from the bottom unit the mobile pet bed functions similarly to a traditional pet bed. When the top unit is attached to the bottom unit the mobile pet bed functions similarly to a crate. Likewise, U.S. Pat. No. 5,078,096 teaches a curvilinear, four-sided pyramidal container is disclosed for housing of small household pets. The container carries a rigid bottom insert and is supported by a rod frame having a square, releasably interconnected bottom element formed of four interconnected semi-rigid rods and two arched, resiliently deformable support rods extending upwardly between opposed corners of the structure, all said rods carried in loops defined on the inner surface of the cover. The support rods are selectively removable to allow assembly and collapse of the structure for storage.

Numerous other examples exist in the art of collapsible or otherwise transportable pet containment apparatuses. No examples exist, however, that provide, among other things, a multipurpose enclosure for containment and independent pet entry and exit; are readily collapsible; are configurable between multiple positions to enable containment, transport, and independent pet entry; and, and are easily cleaned and stored.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present invention is a pet containment apparatus comprising at least two opposing A-frame assemblies, the at least two opposing support assemblies having at least two support legs, the at least two support legs being pivotably coupled at an upper portion and pivotably coupled at a lower portion, the lower portion of the support legs being coupled with a support arm having a connection member at an approximate midpoint; at least two base frame members, the at least two base frame members being pivotably coupled to the at least two opposing support assemblies in substantial alignment with the support arm; and, at least two containment frame members, the at least two containment frame members defining an upper perimeter and pivotably coupled to the upper portion of the support assemblies, and pivotably coupled to a lateral portion of the at least two support legs of the support assemblies with at least one support arm.

Another object of the present invention is a pet containment apparatus comprising at least two opposing A-frame assemblies, the at least two opposing A-frame assemblies having at least two support legs, the at least two support legs being pivotably coupled at an upper portion and pivotably coupled at a lower portion, the lower portion of the support legs being coupled with a support arm having a hinged member at an approximate midpoint; at least two base frame members, the at least two base frame members being pivotably coupled to the at least two opposing A-frame assemblies in substantial alignment with the support arm; at least two containment frame members, the at least two containment frame members defining a substantially rectangular upper perimeter and pivotably coupled to the upper portion of the A-frame assemblies, and pivotably coupled to a lateral portion of the at least two support legs of the A-frame assemblies with at least one hinged support arm; and, a fabric material coupled to a perimeter of the at least two base members and the at least two containment frame members, the fabric material extending between opposing perimeters of the at least two base members and terminating along the substantially rectangular upper perimeter of the at least two containment frame members, defining a closed bottom portion and an open top portion.

Still another object of the present invention is a pet containment apparatus comprising at least two opposing A-frame assemblies, the at least two opposing A-frame assemblies having at least two support legs, the at least two support legs being pivotably coupled at an upper portion and pivotably coupled at a lower portion, the lower portion of the support legs being coupled with support arms having hinged members at an approximate midpoint, the hinged members having a locking mechanism selectively configured to extend the at least two support legs between an extended locked position, and a folded disengaged position; at least two base frame members, the at least two base frame members being pivotably coupled to the at least two opposing A-frame assemblies in substantial alignment with the support arms, the at least two base frame members and the support arms defining a substantially rectangular base perimeter; at least two containment frame members, the at least two containment frame members defining a substantially rectangular upper perimeter and pivotably coupled to the upper portion of the A-frame assemblies, and pivotably coupled to a lateral portion of the at least two support legs of the A-frame assemblies with at least one hinged support arm, the at least one hinged support arm having a locking mechanism configured to selectively position the at least two containment frame members from an extended position when engaged, to a lowered position when disengaged; and, a fabric material coupled to a perimeter of the at least two base members and the at least two containment frame members, the fabric material extending between opposing perimeters of the at least two base members and terminating along the substantially rectangular perimeter of the at least two containment frame members, defining a closed bottom portion and an open top portion.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is an exploded view of a collapsible pet containment apparatus according to an embodiment.

FIG. 2 is a perspective view of a collapsible pet containment apparatus showing a phantom view of a fabric cover, according to an embodiment.

FIG. 3 is a perspective view of a collapsible pet containment apparatus in a collapsed configuration, according to an embodiment.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Embodiments of the present disclosure describe a collapsible pet containment apparatus that includes horizontal upper and lower frames supported on opposing sides by two vertical A-frames. Each of the upper and lower frames are formed by two half-frames, such that the upper and lower frame and the two A-frames form a framework that may be collapsed in half by means of fold connectors, fold joints, and the like. A mesh fabric attached to the upper and lower frame perimeters may define walls for the framework, and a base pad may be located inside a perimeter of the lower frame to define a bottom. The apparatus can be folded in half to extend or collapse the whole framework directly, without the need to remove the base pad.

Embodiments of the present disclosure enable a pet containment apparatus for multiple uses, including among other things, a training tool for new puppies being house broken; a sanctuary for an older dog with decreased motor skills; a safe area for a new animal being introduced into the household; a bed for growing pets; a confinement area for newborn pets; an area for pets healing from surgery or injury; a playpen for dogs while traveling outside the home; pet containment while staying in a hotel, motel, or camp group; a staging area before a pet show or competition; a holding pen for pets awaiting pick-up after appointments with vets, groomers, or daycare; or a containment area for multiple pets.

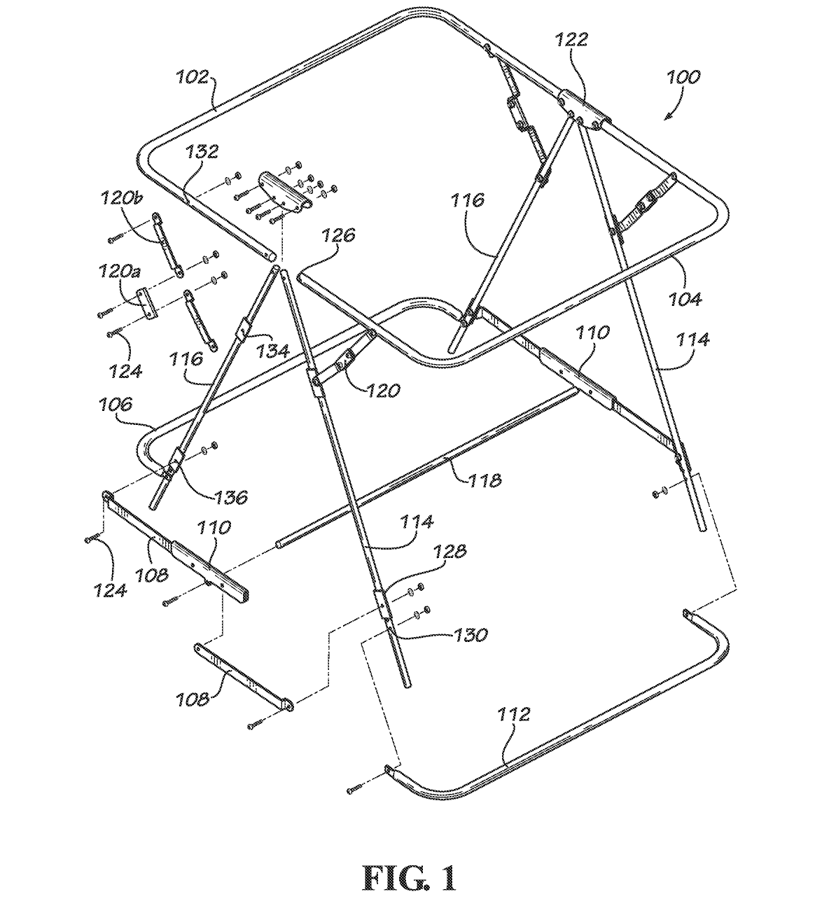

FIG. 1 is an exploded view of a collapsible pet containment apparatus in an extended configuration. In an embodiment, pet containment apparatus 100 is comprised of substantially rectangular upper and lower frames pivotably attached to a pair of opposing A-frame assemblies. Upper and lower frames may be substantially triangular, square, circular, oval, or any polygonal configuration defining a perimeter. A-frame assemblies may be comprised of any assembly of support members configured to provide structure to a pet containment apparatus 100 and move from an extended position to a collapsed position. In an embodiment support members may be configured substantially in an “A” shape when extended, but a substantially parallel configuration, an accordion configuration, and the like, are anticipated. Upper and lower frames and A-frame assemblies may be made of any substantially tubular material, such as PVC tubing, stainless steel tubing, aluminum tubing, and the like. Substantially tubular material may be a pipe, rod, hollow, solid, conical, right prismatic, and the like. The upper frame may be comprised of a left frame portion 102 and a right frame portion 104. Left frame portion 102 and right frame portion 104 may be substantially identical but for their configuration in the assembly, and when arranged in a parallel configuration form a rectangular perimeter that defines the upper frame of pet containment apparatus 100. Left frame portion 102 and right frame portion 104 may have frame connector apertures 126 for connection to frame connector 122, and support arm apertures 132 for connection to support arm 120. Left frame portion 102 and right frame portion 104 may be pivotably coupled to right A-frame leg 114 and left A-frame leg 116 by coupling left frame portion 102 and right frame portion 104 and right A-frame leg 114 and left A-frame leg 116 to frame connector 122 using screw set 124. In an embodiment, screw set 124 may include a machine screw or bolt, washer, and nut combination, but any mechanically equivalent alternative is readily substitutable.

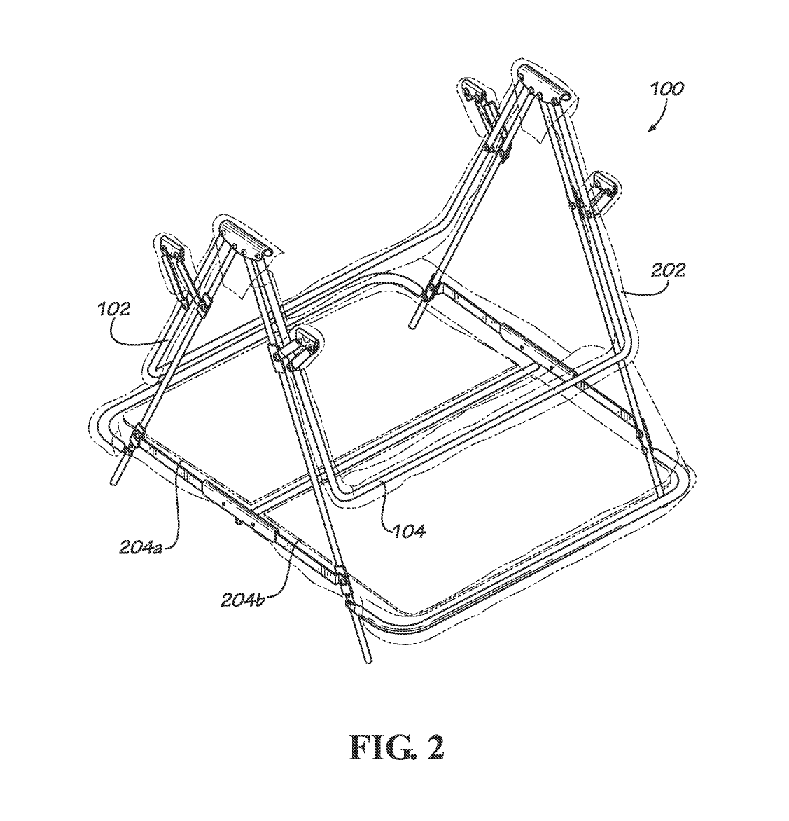

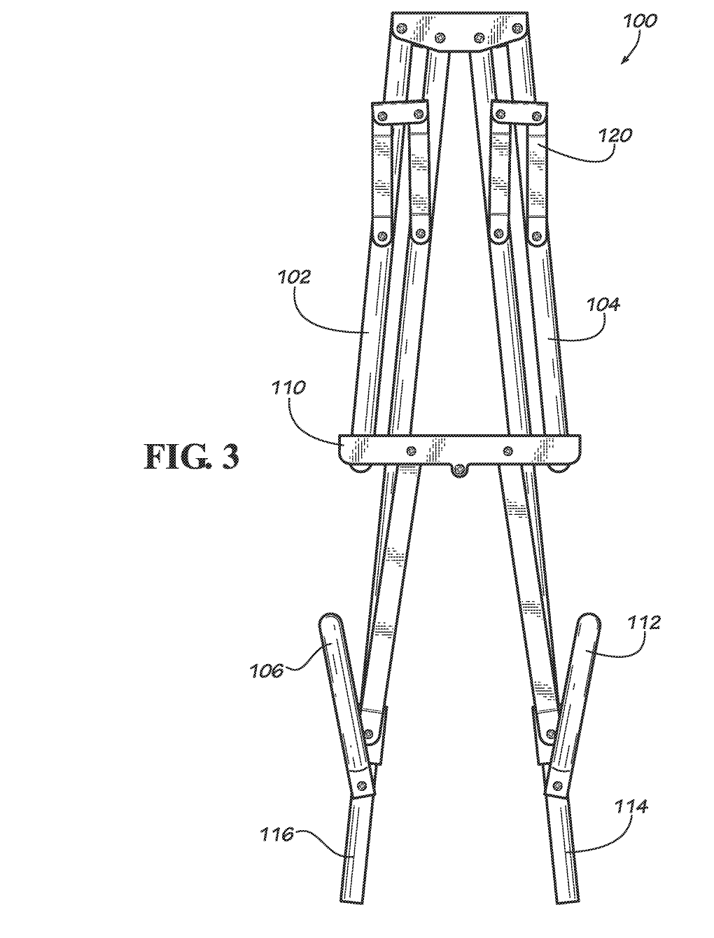

The A-frame assembly of pet containment apparatus 100 may be comprised of right A-frame leg 114, left A-frame leg 116, A-frame support arms 108 and A-frame hinge spreader 110. Right A-frame leg 114 and left A-frame leg 116 may be connected to form an “A” shaped configuration by coupling A-frame support arms 108 to A-frame support arm connection aperture 136 using screw set 124, and pivotably coupling terminal ends of A-frame support bars 108 to A-frame hinge spreader 110. A-frame support arms 108 may pivot between an extended position (as shown in FIG. 1) and a collapsed position (as shown in FIG. 3). In an embodiment, pet containment apparatus 100 is comprised of two A-frame assemblies structurally supported by an A-frame support bar 118. A-frame support bar 118 may be coupled at opposing ends to a first and a second A-frame hinge spreader 110. Right A-frame leg 114 and left A-frame leg 116 may be coupled to perimeter portions of left frame portion 102 and right frame portion 104 by coupling terminal ends of support arm 120 to support arm aperture 132 and A-frame support arm aperture 134. Support arm 120 may be comprised of support arms 120b coupled to support hinge 120a such that support arm may be configured from an extended position (as shown in FIG. 1) to a folded position (as shown in FIG. 2).

The lower frame of pet containment apparatus 100 is comprised substantially of left base frame 106 and right base frame 112. Left base frame 106 and right base frame 112 form a substantially rectangular perimeter when coupled to right A-frame leg 114 and left A-frame leg 116. Left base frame 106 may be coupled at terminal ends to left A-frame legs 116, and right base frame 112 may be coupled at terminal ends to right A-frame legs 114, through base frame aperture 130 using screw set 124. Left base frame 106 and right base frame 112 should be pivotably connected to left A-frame legs 116 and right A-frame legs 114, respectively, to enable positioning from an extended position (as shown in FIG. 1) to a folded position (as shown in FIG. 3).

FIG. 2 is a perspective view of a collapsible pet containment apparatus showing a phantom view of a fabric cover, according to an embodiment. Pet containment apparatus 100 is shown in an extended position with left frame portion 102 and right frame portion 104 lowered to a disengaged configuration. Lowering either left frame portion 102 or right frame portion 104, or both, is meant to enable a pet such as a dog to independently move from an interior portion of pet containment apparatus 100 to outside of pet containment apparatus 100, at will. In a preferred embodiment, pet containment apparatus 100 has fabric covering 202 that is attached to perimeter portions of the upper and lower frames, and extends along a substantially rectangular base perimeter and terminates along the upper frame perimeter, defining a bottom and side walls. A bottom insert 204 rests on the lower frame to give structure to the floor of pet containment apparatus 100, and may be comprised of a left insert 204a and a right insert 204b such that pet containment apparatus 100 may be configured in a folded position (as shown in FIG. 3) without having to remove bottom insert 204. Bottom insert 204 could be a single insert that would need to be removed prior to folding pet containment apparatus 100. Bottom insert 204 may also fold to accommodate a folded configuration of pet containment apparatus 100, and be configured as a singular insert. Bottom insert 204 may be a solution dyed acrylic over a wood or composite board, or a plastic board sufficient to support the weight of a large dog Bottom insert 204 may define a substantially planar base portion to define a “floor” of pet containment apparatus 100.

In an embodiment, fabric covering 202 may have different material qualities for the sides and the bottom. The bottom may be made of a soft, pliable fabric that provides resistance to outdoor elements such as water, wind or sun. In an embodiment, fabric covering 202 defines pockets on its bottom portion to house left insert 204a and a right insert 204b. There may be a trim material on the perimeter edges of fabric covering 202. The trim material may add strength to the perimeter edges of fabric covering 202 and may be comprised of a denser fabric in relation to the “walls” defined by fabric covering 202. Mesh material may be used to connect the trim material around the top and bottom frames to define “walls,” or an otherwise substantially vertical perimeter running from a bottom portion to a top portion such the mesh material defines an interior portion of pet containment apparatus 100. Mesh material may include any class of semi-permeable barrier made of connected strands of metal, fiber, or other flexible or ductile material. An exemplary trim and bottom material may be any durable fabric, including outdoor fabric such as canvas, or awning-type fabric, for example fabrics marketed under the registered trademark SUNBRELLA. An exemplary mesh material for the sides of the manufacture is an open weave vinyl-coated polyester fabric. Fabric cover 202 may be comprised of all the same fabric. In an embodiment, fabric cover 202 is made from any substantially durable fabric, including outdoor fabric such as canvas, or awning-type fabric. In an embodiment, fabric cover 202 may include a removable top configured to selectively fit around a perimeter portion of the upper frame of pet containment apparatus 100. The removable top may have an elastic perimeter, hook and loop fastener, drawstring, or any temporary engagement fastener to enable selective engagement with the upper frame perimeter.

FIG. 3 is a perspective view of a collapsible pet containment apparatus in a folded configuration, according to an embodiment. In an embodiment, pet containment apparatus 100 may be configured in a substantially folded configuration in which A-frame hinge spreader 110 and support arm 120 are configured in a disengaged position to enable left frame portion 102 and right frame portion 104, and right A-frame leg 114 and left A-frame leg 116 to be configured substantially parallel in relation to each other such that pet containment apparatus 100 may be stored in a smaller space relative to its extended position (as shown in FIG. 1).

Embodiments of the present disclosure may be made to any scale to accommodate one or more of any size pet. An illustrative embodiment may measure in the range of approximately 24-48 inches across from A-frame to A-frame, and 24-48 inches from gate to gate (approximately 24-48 inches square). The bottom frame portion may be raised approximately one to ten inches from the ground. The measurement from the bottom to the top of the apparatus may typically measure in the range of approximately 18-48 inches. The apparatus may typically measure 18-36 inches from the top of the A-frame connector to the bottom of the lower frame. The A-frame support legs may typically measure 12-36 inches from the floor to the connector at the top of the A-frame. The A-frame assembly may typically be 12-36 inches from leg to leg. The hinge spreaders in each A-frame, for a 24-48 inch pet containment area, will typically measure 12-36 inches from leg to leg. Additional elements such as a carrying strap or a carrying pouch may be attached to the assembly to aid in storage or transport. Such elements may be removably attached to an interior or exterior portion of pet containment apparatus 100, and may include a detachable means for storing pet accessories.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

What is claimed is:

1. A pet containment apparatus comprising:
at least two opposing support assemblies, the at least two opposing support assemblies having at least two support legs, the at least two support legs being pivotably coupled at an upper portion and pivotably coupled at a lower portion, the lower portion of the support legs being coupled with a support arm;
at least two base frame members, the at least two base frame members being pivotably coupled to the at least two opposing support assemblies in substantial alignment with the support arm; and,
at least two containment frame members, the at least two containment frame members defining an upper perimeter and pivotably coupled to the upper portion of the support assemblies, and pivotably coupled to a lateral portion of the at least two support legs of the support assemblies with at least one support arm.

2. The pet containment apparatus of claim 1 further comprising a fabric material coupled to a perimeter of the at least two base members and the at least two containment frame members, the fabric material extending between opposing perimeters of the at least two base members and terminating along the upper perimeter of the at least two containment frame members, defining a closed bottom portion and an open top portion.

3. The pet containment apparatus of claim 1 wherein the at least one support arm further comprises a locking mechanism selectively configured to hold the at least two containment frame members in an extended position when engaged, and lower the at least two containment frame members when disengaged.

4. The pet containment apparatus of claim 1 wherein the at least two base frame members define a substantially rectangular perimeter.

5. The pet containment apparatus of claim 1 wherein the at least two support legs, the at least two base frame members, and at least two containment frame members are made from a substantially tubular material.

6. The pet containment apparatus of claim 1 further comprising a fabric material having a substantially elastic rectangular perimeter selectively engaged with the upper perimeter of the at least two containment frame members, the fabric material defining a top.

7. The pet containment apparatus of claim 2 further comprising a substantially planar base portion removably housed in an inside perimeter portion defined by the at least two base frame portions.

8. The pet containment apparatus of claim 7 wherein the substantially planar base portion further comprises at least two sections.

9. A pet containment apparatus comprising:
at least two opposing A-frame assemblies, the at least two opposing A-frame assemblies having at least two support legs, the at least two support legs being pivotably coupled at an upper portion and pivotably coupled at a lower portion, the lower portion of the support legs being coupled with a support arm having a hinged member at an approximate midpoint;
at least two base frame members, the at least two base frame members being pivotably coupled to the at least two opposing A-frame assemblies in substantial alignment with the support arm;
at least two containment frame members, the at least two containment frame members defining a substantially rectangular upper perimeter and pivotably coupled to the upper portion of the A-frame assemblies, and pivotably coupled to a lateral portion of the at least two support legs of the A-frame assemblies with at least one hinged support arm; and,
a fabric material coupled to a perimeter of the at least two base members and the at least two containment frame members, the fabric material extending between opposing perimeters of the at least two base members and terminating along the substantially rectangular upper perimeter of the at least two containment frame members, defining a closed bottom portion and an open top portion.

10. The pet containment apparatus of claim 9 further comprising a substantially planar base portion removably housed in an inside perimeter portion defined by the at least two base frame portions.

11. The pet containment apparatus of claim 9 wherein the at least one hinged support arm further comprises a locking mechanism selectively configured to position the at least two containment frame members in an extended position when engaged, and lower the at least two containment frame members when disengaged.

12. The pet containment apparatus of claim 9 further comprising a fabric material having a substantially elastic rectangular perimeter selectively engaged with the substantially rectangular perimeter of the at least two containment frame members, the fabric material defining a top.

13. The pet containment apparatus of claim 9 wherein the at least two support legs, the at least two base frame members, and at least two containment frame members are made from a substantially tubular material.

14. The pet containment apparatus of claim 9 wherein the hinged member further comprises a locking mechanism selectively configured to extend the at least two support legs of the at least two A-frames between an extended locked position, and a folded disengaged position.

15. The pet containment apparatus of claim 10 wherein the substantially planar base portion further comprises at least two sections.

16. A pet containment apparatus comprising:
at least two opposing A-frame assemblies, the at least two opposing A-frame assemblies having at least two support legs, the at least two support legs being pivotably coupled at an upper portion and pivotably coupled at a lower portion, the lower portion of the support legs being coupled with support arms having hinged members at an approximate midpoint, the hinged members having a locking mechanism selectively configured to extend the at least two support legs between an extended locked position, and a folded disengaged position;
at least two base frame members, the at least two base frame members being pivotably coupled to the at least two opposing A-frame assemblies in substantial alignment with the support arms, the at least two base frame members and the support arms defining a substantially rectangular base perimeter;
at least two containment frame members, the at least two containment frame members defining a substantially rectangular upper perimeter and pivotably coupled to the upper portion of the A-frame assemblies, and pivotably coupled to a lateral portion of the at least two support legs of the A-frame assemblies with at least one hinged support arm, the at least one hinged support arm having a locking mechanism configured to selectively position the at least two containment frame members from an extended position when engaged, to a lowered position when disengaged; and,
a fabric material coupled to a perimeter of the at least two base members and the at least two containment frame members, the fabric material extending between opposing perimeters of the at least two base members and terminating along the substantially rectangular perimeter of the at least two containment frame members, defining a closed bottom portion and an open top portion.

17. The pet containment apparatus of claim 16 further comprising a substantially planar base portion housed in an inside perimeter portion defined by the substantially rectangular base perimeter.

18. The pet containment apparatus of claim 16 further comprising a fabric material having a substantially elastic rectangular perimeter removably engaged with the substantially rectangular perimeter of the at least two containment frame members, the fabric material defining a top.

19. The pet containment apparatus of claim 16 wherein the at least two support legs, the at least two base frame members, and at least two containment frame members are made from a substantially tubular material.

20. The pet containment apparatus of claim 17 wherein the substantially planar base portion further comprises at least two sections.
